(19) United States
(12) Patent Application Publication
(10) Pub. No.: US 2026/0003947 A1
(43) Pub. Date: Jan. 1, 2026

(54) IMAGE PROCESSING FOR AUTHENTICATION

(71) Applicant: TENCENT TECHNOLOGY (SHENZHEN) COMPANY LIMITED, Shenzhen (CN)

(72) Inventors: Jun WANG, Shenzhen (CN); Jinkun HOU, Shenzhen (CN); Runzeng GUO, Shenzhen (CN); Shaoming WANG, Shenzhen (CN)

(73) Assignee: TENCENT TECHNOLOGY (SHENZHEN) COMPANY LIMITED, Shenzhen, GD (CN)

(21) Appl. No.: 19/320,794

(22) Filed: Sep. 5, 2025

Related U.S. Application Data
(63) Continuation of application No. PCT/CN2024/097239, filed on Jun. 4, 2024.

(30) Foreign Application Priority Data
Jul. 28, 2023 (CN) 202310946844.4

(51) Int. Cl. G06F 21/32; G02B 27/01

(52) U.S. Cl. CPC G06F 21/32; G02B 27/017

(57) ABSTRACT

Some aspects of the disclosure provide a method of image processing for authentication. In some examples, indication information is displayed by a head-mounted display device, the indication information instructs a user of the head-mounted display device to observe a specified position in a display space of the head-mounted display device. An eye image of the user is obtained. Key point positions of at least two key points of an eye of the user are obtained from the eye image. An observing position of the user is determined based on relationships between the key point positions of the at least two key points. When the observing position of the user matches with the specified position, an authentication of the user is determined to succeed. Apparatus and non-transitory computer-readable storage medium counterpart embodiments are also contemplated.

### RELATED APPLICATIONS

The present application is a continuation of International Application No. PCT/CN2024/097239, filed on Jun. 4, 2024, which claims priority to Chinese Patent Application No. 202310946844.4, filed on Jul. 28, 2023. The entire disclosures of the prior applications are hereby incorporated by reference.

### FIELD OF THE TECHNOLOGY

Embodiments of this disclosure relate to the technical field of image processing, and in particular, to an image processing method and apparatus for authentication, a device, and a storage medium.

### BACKGROUND OF THE DISCLOSURE

With the continuous development of network technologies, the security of networks/data receives more and more attentions. When a user uses an electronic product or a network application, there are more and more scenarios that requires user authentication.

In the related art, user authentication is usually implemented in a manner such as face video authentication and password authentication. For example, a living body authentication scenario of face authentication is used as an example. First, a user needs to adjust a photographing angle and distance of a front-facing camera of a mobile phone, so that the front-facing camera can clearly capture a human face. Then, the user performs operations such as blinking and shaking the head according to a prompt. An authentication program detects, through an image acquired by the front-facing camera of the mobile phone, whether living body authentication on the current user succeeds.

However, the above authentication mode is usually complex in operation, and the user authentication process usually needs to last for particular time. Consequently, authentication efficiency is low.

### SUMMARY

Embodiments of this disclosure provide an image processing method and apparatus for authentication, a device, and a storage medium, and can improve authentication efficiency. Technical solutions are as follows.

Some aspects of the disclosure provide a method of image processing for authentication. In some examples, indication information is displayed by a head-mounted display device, the indication information instructs a user of the head-mounted display device to observe a specified position in a display space of the head-mounted display device. An eye image of the user is obtained. Key point positions of at least two key points of an eye of the user are obtained from the eye image. An observing position of the user is determined based on relationships between the key point positions of the at least two key points. When the observing position of the user matches with the specified position, an authentication of the user is determined to succeed.

Some aspects of the disclosure provide an image processing apparatus that includes processing circuitry configured to perform the method of image processing for authentication.

Some aspects of the disclosure also provide a non-transitory computer-readable storage medium storing instructions which when executed by at least one processor cause the at least one processor to perform the method of image processing for authentication.

In one aspect, an image processing method for authentication is provided, which is performed by a computer device and including: displaying indication information through a head-mounted display device, the indication information being configured for instructing a user to observe a specified position in a display space of the head-mounted display device; obtaining an eye image of the user; obtaining positions of at least two key points of an eye of the user from the eye image; and determining, in a case that a position that is indicated by a relationship between the positions of the at least two key points of the eye of the user and is observed by the user is matched with the specified position, that authentication on the user succeeds.

In another aspect, a head-mounted display device is provided, including a display screen and an image acquisition component, the image acquisition component pointing to an eyeball position when the head-mounted display device is worn; the display screen being configured to display indication information, the indication information being configured for instructing a user to observe a specified position in a display space of the head-mounted display device; the image acquisition component being configured to acquire an eye image of the user; and the eye image being configured for obtaining positions of at least two key points of an eye of the user, so as to determine, in a case that a position that is indicated by a relationship between the positions of the at least two key points of the eye of the user and is observed by the user is matched with the specified position, that authentication on the user succeeds.

In another aspect, an image processing apparatus for authentication is provided, including: a display module, configured to display indication information through a head-mounted display device, the indication information being configured for instructing a user to observe a specified position in a display space of the head-mounted display device; an image obtaining module, configured to obtain an eye image of the user; a key point obtaining module, configured to obtain positions of at least two key points of an eye of the user from the eye image; and an authentication module, configured to determine, in a case that a position that is indicated by a relationship between the positions of the at least two key points of the eye of the user and is observed by the user is matched with the specified position, that authentication on the user succeeds.

In some embodiments, the head-mounted display device is a virtual reality (VR) display device, or the head-mounted display device is an augmented reality (AR) display device.

In some embodiments, the display module is configured to display the indication information at the specified position through the VR display device or the AR display device.

In some embodiments, the image obtaining module is configured to obtain the eye image acquired by an image acquisition component arranged in the head-mounted display device; and the image acquisition component points to an eyeball position when the head-mounted display device is worn.

In some embodiments, the at least two key points of the eye of the user include at least one of the following: at least two key points corresponding to the left eye of the user; and at least two key points corresponding to the right eye of the user.

In some embodiments, the at least two key points corresponding to the left eye of the user include a left corner key point of the left eye of the user, a right corner key point of the left eye of the user, and a pupil center point of the left eye of the user; the at least two key points corresponding to the right eye of the user include a left corner key point of the right eye of the user, a right corner key point of the right eye of the user, and a pupil center point of the right eye of the user; and the authentication module is configured to: obtain a first distance, a second distance, a third distance, and a fourth distance, the first distance being a distance between the left corner key point of the left eye and the pupil center point of the left eye; the second distance being a distance between the right corner key point of the left eye and the pupil center point of the left eye; the third distance being a distance between the left corner key point of the right eye and the pupil center point of the right eye; the fourth distance being a distance between the right corner key point of the right eye and the pupil center point of the right eye; and determine, in a case that a position that is indicated by a relationship between the first distance, the second distance, the third distance, and the fourth distance and is observed by the user is matched with the specified position, that the authentication on the user succeeds.

In some embodiments, the authentication module is configured to: determine a viewing direction of the user based on a magnitude relationship between the first distance, the second distance, the third distance, and the fourth distance; and determine, in a case that the viewing direction of the user is matched with the specified position, that the authentication on the user succeeds.

In some embodiments, the authentication module is configured to: determine, in a case that the second distance is greater than the first distance and the fourth distance is greater than the third distance, that the viewing direction of the user is toward the left; and determine, in a case that the first distance is greater than the second distance and the third distance is greater than the fourth distance, that the viewing direction of the user is toward the right.

In some embodiments, the specified position moves with time; and the authentication module is configured to: obtain a change trend of a first ratio of the first distance to the second distance; obtain a change trend of a second ratio of the third distance to the fourth distance; and determine, in a case that the change trend of the first ratio and the change trend of the second ratio are matched with a moving direction of the specified position, that the authentication on the user succeeds.

In some embodiments, the key point obtaining module is configured to input the eye image to a key point detection model, to obtain the positions, which are outputted by the key point detection model, of the at least two key points of the eye of the user, the key point detection model being a machine learning model that is obtained in advance by training through an eye image sample and the positions of the at least two key points marked by the eye image sample.

In another aspect, a computer device is provided, including a processor and a memory, the memory having at least one computer program stored therein, and the at least one computer program being loaded and executed by the processor to implement the above image processing method for authentication.

In still another aspect, a computer-readable storage medium is provided, having a computer program stored therein, the computer program being loaded and executed by a processor to implement the above image processing method for authentication.

In yet another aspect, a computer program product is provided, including a computer program, the computer program being stored in a computer-readable storage medium (e.g., non-transitory computer-readable storage medium); a processor (an example of processing circuitry) of a computer device reading the computer program from the computer-readable storage medium and executing the computer program, to cause the computer device to perform the image processing method for authentication in the above various implementations.

The technical solutions provided by the embodiments of this disclosure may include the following beneficial effects.

The information displayed through the head-mounted display device instructs the user to observe the specified position in the display space of the head-mounted display device, and the eye image of the user is obtained at the same time. When it is determined, according to the relationship between the positions of the at least two key points of the eye of the user obtained from the image of the user, that the position observed by the user is matched with the specified position, it is determined that the authentication on the user succeeds. The head-mounted display device can rotate along with the head of the user, so that a relationship between positions of key points in the eye image of the user can accurately represent a position currently observed by the user, thus determining whether the user is observing the specified position, to accurately authenticate the user. Meanwhile, the user only needs to roll the eyeballs and observe the specified position to implement the above process without performing other operations. This can greatly simplify user operations during authentication, thus improving authentication efficiency while ensuring authentication accuracy.

### BRIEF DESCRIPTION OF THE DRAWINGS

FIG. 1 is a schematic diagram of an implementation environment according to an embodiment of this disclosure.

FIG. 2 is a flowchart of an image processing method for authentication according to an embodiment of this disclosure.

FIG. 3 is a flowchart of an image processing method for authentication according to an embodiment of this disclosure.

FIG. 4 is a flowchart of an image processing method for authentication according to an embodiment of this disclosure.

FIG. 5 is a flowchart of an image processing method for authentication according to an embodiment of this disclosure.

FIG. 6 is a flowchart of an image processing method for authentication according to an embodiment of this disclosure.

FIG. 7 is a schematic diagram of a scenario interface according to this disclosure.

FIG. 8 is a diagram of a principle of a DeepPose algorithm according to this disclosure.

FIG. 9 is a diagram of a principle of another DeepPose algorithm according to this disclosure.

FIG. 10 is a schematic diagram of prediction of key points of an eye through a DeepPose algorithm according to this disclosure.

FIG. 11 is a diagram of presentations of two eyes when the two eyes look to the left and to the right according to this disclosure.

FIG. 12 is an effect diagram of key point detection according to this disclosure.

FIG. 13 is a schematic diagram of connecting lines between corners and pupils according to this disclosure.

FIG. 14 is a flowchart of authentication according to this disclosure.

FIG. 15 is a block diagram of an image processing apparatus for authentication according to an embodiment of this disclosure.

FIG. 16 is a structural block diagram of a computer device according to an embodiment of this disclosure.

### DESCRIPTION OF EMBODIMENTS

The following describes technical solutions in embodiments of this disclosure with reference to the accompanying drawings. The described embodiments are some of the embodiments of this disclosure rather than all of the embodiments. Other embodiments are within the scope of this disclosure.

Examples of terms involved in the aspects of the disclosure are briefly introduced. The descriptions of the terms are provided as examples only and are not intended to limit the scope of the disclosure.

1) Infrared image: An infrared sensor acquires an infrared image of wide-range infrared imaging.

Since an iris of an eye has a special absorption feature for infrared and avoids interference of VR color imaging in a virtual reality (VR) technology scenario, so that acquiring eye information from an infrared image can achieve good anti-interference and recognition effects.

2) Living body detection: The living body detection is a method for determining a real physiological feature of an object in some identity authentication scenarios. For example, in a face recognition application, the living body detection can authenticate, by using a technology such as key point positioning and detection, whether a user performs an in-person operation, such as blinking, opening the mouth, shaking the head, and nodding. Common attack measures such as remaking photographs, videos, face changes, masks, blocking, 3D animations, and screen photographs can be effectively defended, thereby helping the user to distinguish wrong behaviors and ensuring benefits of the user.

3) Identity authentication: It is also referred to as “authentication”, which is a technology for confirming a user identity through particular measures. There are many identity authentication methods, for example, identity authentication based on a shared key, identity authentication based on a public key encryption algorithm, and identity authentication based on reserved information.

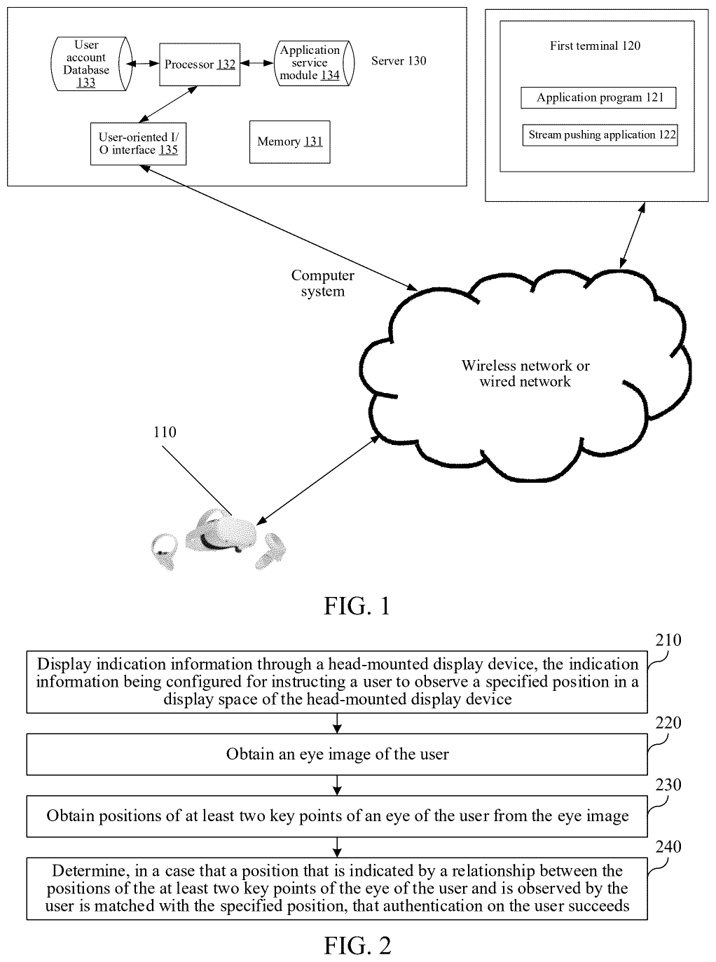

FIG. 1 is a schematic diagram of an implementation environment according to one embodiment of this disclosure. The implementation environment may include: a head-mounted display device 110. In some embodiments, the implementation environment may further include a first terminal 120. In some embodiments, the implementation environment may further include a server 130.

The above server may be an independent physical server, or may be a server cluster or a distributed system formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. The terminal may be a smartphone, a tablet computer, a notebook computer, a desktop computer, a smart speaker, a smart watch, and the like, but is not limited thereto. The terminal and the server may be directly or indirectly connected in a wired or wireless communication protocol. This is not limited here in this disclosure.

In some embodiments, the head-mounted display device 110 may display an image on a display screen. Alternatively, the head-mounted display device 110 may exchange data with the server 130 to display an image on a display screen of the head-mounted display device 110. For example, an application program may be installed in the head-mounted display device 110. The application program may be a VR application program (such as a VR game), an AR application program (such as an AR game), or the like.

Only one head-mounted display device is shown in FIG. 1, but in different embodiments, a plurality of other head-mounted display devices may be connected to the server 130 or the first terminal 120.

In some aspects, an application program 121 and a stream pushing application 122 may be installed and run on the first terminal 120. The application program 121 may display an image on the display screen of the head-mounted display device 110 alone, or may exchange data with the server 130 to display an image on the display screen of the head-mounted display device 110. For example, the application program 121 may be a VR application program (such as a VR game) or an AR application program (such as an AR game).

Only one terminal is shown in FIG. 1, but in different embodiments, a plurality of other terminals that can be connected to the head-mounted display devices 110 or the server 130. In some embodiments, there is one or more terminals that are terminals corresponding to developers. A development platform for developing the application program 121 or the stream pushing application 122 is installed on the terminal.

The head-mounted display device 110 and another head-mounted display device may be connected to the first terminal 120 or the server 130 through a wireless network or a wired network.

The head-mounted display device 110 may include a display and an input component. The display may be configured to display an encoded video stream of an image of a virtual scenario/an augmented reality scenario. The input component is configured to: receive input data of a user and return the input data to the first terminal 120 or the server 130. The input component may include at least one of a sensor (such as a motion sensor, a touch sensor, or a light sensor) and a physical key. The input data may include sensor data, press data of the physical key, and the like.

The server 130 includes at least one of one server, a server cluster including a plurality of servers, a cloud computing platform, and a virtualization center. The server 130 may provide a backend support to the application program 121 run in the terminal or the application program in the head-mounted display device 110. In some embodiments, the server 130 is in charge of primary computing work, and the terminal or the head-mounted display device 110 is in charge of secondary computing work. Alternatively, the server 130 is in charge of secondary computing work, and the terminal or the head-mounted display device 110 is in charge of primary computing work. Alternatively, the server 130 and the head-mounted display device 110 perform collaborative computing through a distributed computing architecture.

In a schematic example, the server 130 includes a memory 131, a processor 132, a user account database 133, an application service module 134, and a user-oriented input/output (I/O) interface 135. The processor 132 is configured to: load an instruction stored in the server 130 and process data in the user account database 133 and the application service module 134. The user account database 133 is configured to store data of user accounts used by the first terminal 110 and other terminals, for example, avatars of the user accounts, nicknames of the user accounts, and levels of the user accounts. The application service module 134 is configured to provide a backend supporting service of an application program, and the like. The user-oriented I/O interface 135 is configured for establishing communication with the head-mounted display device 110 or the first terminal 120 through the wireless network or wired network for data exchange.

FIG. 2 is a flowchart of an image processing method for authentication according to an embodiment of this disclosure. For ease of description, using a computer device as an executive body for operations is introduced and described. The computer device may be a head-mounted display device, a terminal, or a server. The head-mounted display device may be the head-mounted display device 110 shown in FIG. 1. The terminal may be the terminal 120 shown in FIG. 1. The server may be the server 130 shown in FIG. 1. The method may include the following operations:

Operation 210: Display indication information through a head-mounted display device, the indication information being configured for instructing a user to observe a specified position in a display space of the head-mounted display device.

The display space of the head-mounted display device is a space in which information displayed through the head-mounted display device may exist.

In some embodiments, the display space of the head-mounted display device may be a three-dimensional space. The head-mounted display device may display a specified information element at any position in the three-dimensional space.

Alternatively, the display space of the head-mounted display device may be a two-dimensional planar space, such as a display screen. The head-mounted display device may display a specified information element at any position in the two-dimensional planar space.

The head-mounted display device may include a display screen. In some embodiments, the head-mounted display device may include a single display screen or two display screens. When the head-mounted display device includes two display screens, the two display screens respectively correspond to the two eyes of a user. The two display screens may respectively display images when the two eyes observe an image element/object in a virtual space, thereby creating a three-dimensional display effect for the user.

For example, the head-mounted display device is a virtual reality (VR) display device, or the head-mounted display device is an augmented reality (AR) display device.

Just as its name implies, virtual reality is a combination of virtuality and reality. Theoretically, a virtual reality (VR) technology is a computer simulation system that may create and experience a virtual world, and may generate a simulated environment by using a computer, so that a user is immersed into the environment. In the VR technology, an electronic signal generated by using data in a real life through a computer technology is combined with various output devices to convert the electronic signal into phenomena that can be perceived by people. These phenomena may be real objects in reality, or may be substances that cannot be seen by naked eyes, and are represented through three-dimensional models. These phenomena are referred to as virtual reality because they are not directly visible to people but are real worlds simulated through the computer technology.

In this embodiment of this disclosure, the VR display device may display a three-dimensional virtual scene to the user. To be specific, a three-dimensional scenario image seen by the user through the VR display device is a simulated world image, such as a VR game image, simulated by the computer. Certainly, the VR display device may be further configured to play a three-dimensional video (a three-dimensional film).

The augmented reality (AR) technology is a technology that skillfully integrates virtual information with a real world. This technology extensively uses various technical measures such as multimedia, three-dimensional modeling, real-time detection and registration, intelligent interaction, and sensing to simulate computer-generated virtual information such as text, images, three-dimensional models, music, and videos, and then applies the virtual information to the real world. Two types of information complement each other to “augment” the real world.

The augmented reality technology is also referred to as AR. The AR technology is new technical content that promotes integration of real world information and virtual world information content. Entity information that is originally hardly experienced in a spatial range of a real world is simulated based on a scientific technology such as a computer. The virtual information content is superposed into the real world for effective application. Furthermore, in this process, the information can be perceived by human senses, thus implementing a sensual experience beyond reality. After a real environment and a virtual object are superposed, the real environment and the virtual object can exist in the same image and space at the same time.

The AR technology not only can effectively present content of the real world, but also can display the virtual information content, and the fine content complements and superposes each other. In visualized AR, a user needs to make the real world overlap a computer graphics based on the head-mounted display device, and can fully see that the real world surrounds the computer graphics after the overlapping. The AR technology mainly includes new technologies and measures such as multimedia, three-dimensional modeling, and scenario fusion. Information content provided by augmented reality is significantly different from information content that can be perceived by people.

The AR display device may be implemented as single-lens or double-lens AR glasses. In addition to being able to transmit light, making a user see the real world behind the lenses, the lenses of the AR glasses may further reflect a virtual image to the positions of the eyes of the user, so that the user can see a virtual image element/object superposed into the real world.

Either the AR display device or the VR display device can display specified information at a specified position.

In some embodiments, the computer device may display the indication information at the specified position through the VR display device or the AR display device.

In this embodiment of this disclosure, to better prompt the user to observe the specified position, the computer device may directly display the indication information at the specified position through the VR display device or the AR display device.

Operation 220: Obtain an eye image of the user.

The above eye image of the user may be an eye image of the user when the user wears the head-mounted display device.

In some aspects, when the user wears the head-mounted display device, the head-mounted display device may display the specified information, so that the eyes of the user may focus on the specified position.

In some embodiments, the computer device may obtain the eye image acquired by an image acquisition component arranged in the head-mounted display device. The image acquisition component points to an eyeball position when the head-mounted display device is worn. For example, the computer device may obtain the eye image acquired by the image acquisition component arranged in the AR display device or the VR display device. For example, in a case that the AR display device or the VR display device displays the indication information at the specified position, the computer device may obtain the eye image acquired by the image acquisition component arranged in the AR display device or the VR display device.

When the user wears the head-mounted display device, an eye of the user are usually blocked by the head-mounted display device. Therefore, if the eye image of the user is acquired by a component except a component inside the head-mounted display device, no clear eye image of the user may be correctly acquired. In view of this, in this embodiment of this disclosure, the image acquisition component may be arranged in the head-mounted display device. Meanwhile, the image acquisition component may point to an eyeball position of the user when the head-mounted display device is worn. In this way, the image acquisition component can accurately acquire a clear eye image of the user, thereby ensuring subsequent authentication accuracy.

In some embodiments, the eye image may be an infrared image.

Operation 230: Obtain positions of at least two key points of an eye of the user from the eye image.

An eye part of a human body may include various types of key points, and each type of key point may further include a plurality of key points.

For example, the eye part of the human body may include one or more key points of an eyelid, one or more key points of an iris, one or more key points of a pupil, and the like.

Operation 240: Determine, in a case that a position that is indicated by a relationship between the positions of the at least two key points of the eye of the user and is observed by the user is matched with the specified position, that authentication on the user succeeds.

When the eye of the user focuses on spatial positions in different directions and at different depths, the positions of the key points of the eye part of the human body may be different. On the contrary, an approximate position (including a direction, a distance, and the like) on which the eye of the user currently focuses/that the eye observes may be deduced through the positions of the key points of the eye part of the human body.

Based on the principle, in the embodiment of this disclosure, a piece of specified information is displayed through the head-mounted display device, to instruct the user to observe the specified position in the display space of the head-mounted display device. When the head-mounted display device is worn at the head of the user, the head-mounted display device rotates with the head of the user. To be specific, no matter how the user turns the head, a position of the information displayed by the head-mounted display device is stationary relative to the eye of the user. The user can observe different positions in the display space of the head-mounted display device only by changing a direction and a focal length of the eyeball, thereby eliminating interference caused by head turning when the user observes the specified position in the display space of the head-mounted display device, and accurately recognize, through the relationship between the positions of the key points of the eye, the position observed by the user. Thus, whether the authentication on the user succeeds is determined by determining whether the position observed by the user is matched with the specified position.

In conclusion, in the solution shown in this embodiment of this disclosure, the information displayed through the head-mounted display device instructs the user to observe the specified position in the display space of the head-mounted display device, and the eye image of the user is obtained at the same time. When it is determined, according to the relationship between the positions of the at least two key points of the eye of the user obtained from the image of the user, that the position observed by the user is matched with the specified position, it is determined that the authentication on the user succeeds. The head-mounted display device can rotate along with the head of the user, so that a relationship between positions of key points in the eye image of the user can accurately represent a position currently observed by the user, thus determining whether the user is observing the specified position, to accurately authenticate the user. Meanwhile, the user only needs to roll the eyeballs and observe the specified position to implement the above process, without performing other operations. This can greatly simplify user operations during authentication, thus improving authentication efficiency while ensuring authentication accuracy.

The solutions shown in the embodiments of FIG. 2 of this disclosure may be applied to a living body detection scenario of a user. For example, according to the solutions shown in FIG. 2, when it is detected that the position that is indicated by the relationship between the positions of the at least two key points of the eye of the user and is observed by the user is matched with the specified position, it may be considered that it is the user performing an in-person operation.

Alternatively, the solutions shown in the embodiments of FIG. 2 may be applied to an identity authentication scenario for a user. For example, through the solutions shown in FIG. 2, different authentication information may be respectively displayed at different positions in the display space of the head-mounted display device through the head-mounted display device. Identity authentication information at the specified position is correct identity authentication information. When it is detected that the position indicated by the relationship between the positions of the at least two key points of the eye of the user and is observed by the user is matched with the specified position, it may be considered that identity authentication information currently observed by the user is correct. In this case, it may be determined that the identity authentication on the user succeeds.

Based on the solutions shown by the embodiments of FIG. 2, in some embodiments, the at least two key points of the eye of the user include at least one of the following: at least two key points corresponding to the left eye of the user; and at least two key points corresponding to the right eye of the user.

In an implementation of this embodiment of this disclosure, the computer device may approximately determine, through the at least two key points of one of the left eye or the right eye, a current observation direction and/or depth of the user, and further determine, when the position indicated by the relationship between the positions of the at least two key points of the eye of the user and is observed by the user is matched with the specified position, that the authentication on the user succeeds. In this solution, only obtaining at least two key points of a single eye can reduce a workload of obtaining and analyzing the positions of the key positions of the eye image, improve authentication efficiency, and save hardware resources. In addition, when eye images of two eyes are respectively acquired, and one eye image has poor quality, authentication may be further performed through the eye image of the other eye, thereby ensuring stability of an authentication process.

In another implementation of this embodiment of this disclosure, the computer device determines, with reference to the at least two key points of each of the left eye and the right eye, a current observation direction and/or depth of the user, to ensure accuracy of a position observed by the user, thereby ensuring authentication accuracy.

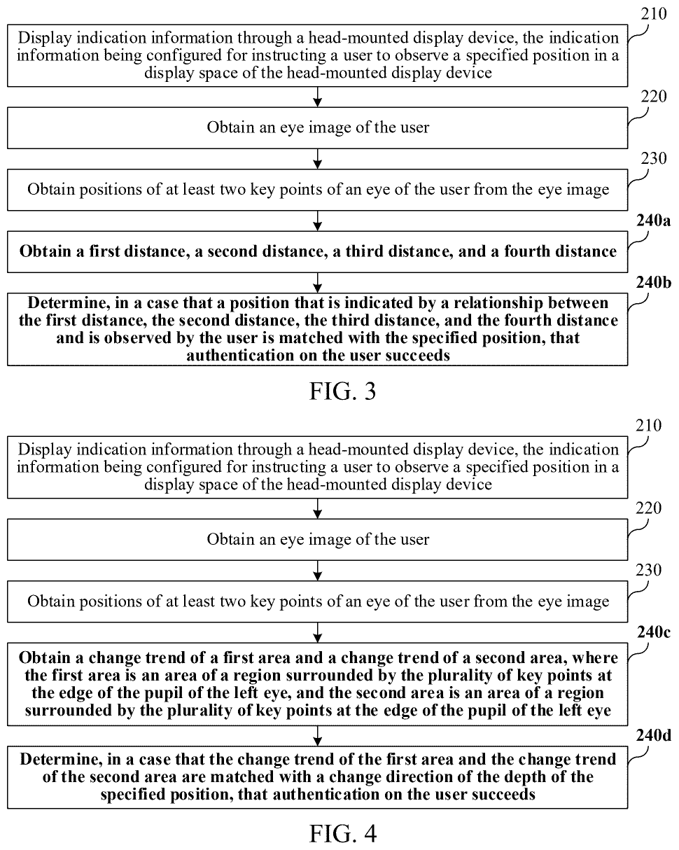

Based on the solutions involved in the embodiments shown in FIG. 2, for the process in which the computer device performs authentication with reference to the at least two key points of each of the left eye and the right eye, refer to FIG. 3. FIG. 3 is a flowchart of an image processing method for authentication according to an embodiment of this disclosure. When the at least two key points of the eye of the user include at least one of the at least two key points corresponding to the left eye of the user and the at least two key points corresponding to the right eye of the user. Moreover, the at least two key points corresponding to the left eye of the user include a left corner key point of the left eye of the user, a right corner key point of the left eye of the user, and a pupil center point of the left eye of the user, and the at least two key points corresponding to the right eye of the user include a left corner key point of the right eye of the user, a right corner key point of the right eye of the user, and a pupil center point of the right eye of the user. Based on the embodiments shown in FIG. 2, in the embodiments shown in FIG. 3, operation 240 may include operation 240a and operation 240b:

Operation 240a: Obtain a first distance, a second distance, a third distance, and a fourth distance.

The first distance is a distance between the left corner key point of the left eye and the pupil center point of the left eye. The second distance is a distance between the right corner key point of the left eye and the pupil center point of the left eye. The third distance is a distance between the left corner key point of the right eye and the pupil center point of the right eye. The fourth distance is a distance between the right corner key point of the right eye and the pupil center point of the right eye.

In this embodiment of this disclosure, the at least two key points corresponding to the left eye of the user at least include the left corner key point of the left eye of the user, the right corner key point of the left eye of the user, and the pupil center point of the left eye of the user. The at least two key points corresponding to the right eye of the user at least include the left corner key point of the right eye of the user, the right corner key point of the right eye of the user, and the pupil center point of the right eye of the user.

Operation 240b: Determine, in a case that a position that is indicated by a relationship between the first distance, the second distance, the third distance, and the fourth distance and is observed by the user is matched with the specified position, that the authentication on the user succeeds.

In some embodiments, the operation of determining, in a case that a position that is indicated by a relationship between the first distance, the second distance, the third distance, and the fourth distance and is observed by the user is matched with the specified position, that the authentication on the user succeeds may include:
determining a viewing direction of the user based on a magnitude relationship between the first distance, the second distance, the third distance, and the fourth distance; and
determining, in a case that the viewing direction of the user is matched with the specified position, that the authentication on the user succeeds.

The determining a viewing direction of the user based on a magnitude relationship between the first distance, the second distance, the third distance, and the fourth distance may mean that the viewing direction of the user is determined through the magnitude relationship between the first distance, the second distance, the third distance, and the fourth distance, and a preset correspondence between a relationship type (for example, being greater than, being less than, and being equal to) of the magnitude relationship and the viewing direction.

In some embodiments, the determining a viewing direction of the user based on a magnitude relationship between the first distance, the second distance, the third distance, and the fourth distance includes:
determining, in a case that the second distance is greater than the first distance and the fourth distance is greater than the third distance, that the viewing direction of the user is toward the left; and
determining, in a case that the first distance is greater than the second distance and the third distance is greater than the fourth distance, that the viewing direction of the user is toward the right.

Here, the viewing direction is a viewing direction in perspective of the user. To be specific, that the viewing direction toward the right means that the viewing direction of the user points to the right hand side of the user. Correspondingly, that the viewing direction toward the left means that the viewing direction of the user points to the left hand side of the user.

In this embodiment of this disclosure, for one image of each of the left and right eyes, the computer device may respectively determine distances between the two corners of each of the left and right eyes and the pupil of each of the left and right eyes, may determine, through the magnitude relationship of the distances between the two corners of each of the left and right eyes and the pupil of each of the left and right eyes, whether the eye of the user looks to the left or the right, and may determine, with reference to the position of the specified position relative to each eye of the user, whether the user observes the specified position, thus determining whether the authentication on the user succeeds. In this process, only whether the eyes of the user look to the left or the right needs to be determined. Determining accuracy is high; a determining logic is simple; and the accuracy and efficiency of authentication can be ensured.

The above embodiment is described by using an example in which the authentication is performed with reference to the at least two key points of each of the left eye and the right eye. In some embodiments, the authentication may alternatively be performed through the at least two key points of the left eye or the right eye. For example, the first distance, the second distance, the third distance, and the fourth distance are still used as an example. If the second distance is greater than the first distance, it may be determined that the viewing direction of the user is to the left. On the contrary, if the first distance is greater than the second distance, it may be determined that the viewing direction of the user is to the right. For another example, if the fourth distance is greater than the third distance, it is determined that the viewing direction of the user is to the left. If the third distance is greater than the fourth distance, it is determined that the viewing direction of the user is to the right.

In the above embodiment, the computer device may flexibly select whether to use the at least two key points of each of the two eyes or use the at least two key points of one eye to perform the authentication. For example, after acquiring the eye images of the two eyes, the computer device may first detect image quality of the eye images of the two eyes, extract key points from an eye image that meets a quality requirement in the eye images of the two eyes, to obtain the at least two key points of the corresponding eye, and then determine, based on the at least two key points extracted, whether the viewing direction of the user is to the left or to the right, to further determine whether the authentication on the user succeeds.

The quality requirement may include at least one of the following:
a definition of the eye image is greater than a definition threshold; and
a size of a visible eyeball region in the eye image is greater than a size threshold.

To be specific, in this embodiment of this disclosure, the computer device may select, from the eye images of the left and the right eyes, an eye image with a sufficiently high definition and a large enough eyeball region, determine, according to the key points of the selected eye image, whether the viewing direction of the user is to the left or the right, and further determine whether the authentication on the user succeeds, thereby improving authentication accuracy.

In some embodiments, the specified position moves with time. The determining, in a case that a position that is indicated by a relationship between the first distance, the second distance, the third distance, and the fourth distance and is observed by the user is matched with the specified position, that the authentication on the user succeeds includes:
obtaining a change trend of a first ratio of the first distance to the second distance;
obtaining a change trend of a second ratio of the third distance to the fourth distance; and
determining, in a case that the change trend of the first ratio and the change trend of the second ratio are matched with a moving direction of the specified position, that the authentication on the user succeeds.

In the above embodiment, the computer device may control the specified position to move to a specified direction within a specified time period, and acquire a plurality of eye images of each of the left eye and the right eye within the specified time period. For the plurality of eye images of the left eye, first ratios of the plurality of eye images are determined according to the at least two key points in the plurality of eye images, and then the change trend of the first ratios is determined according to a sequence of acquisition time points of the plurality of eye images from early to late, namely, whether the first ratios gradually increase or gradually decrease is determined. Correspondingly, for the plurality of eye images of the right eye, second ratios of the plurality of eye images are determined according to the at least two key points in the plurality of eye images, and then the change trend of the second ratios is determined according to a sequence of acquisition time points of the plurality of eye images from early to late, namely, whether the second ratios gradually increase or gradually decrease is determined.

For example, if the first ratio of the first distance to the second distance gradually decreases, and the second ratio of the third distance to the fourth distance also gradually decreases, it is determined that the moving direction of the specified position is to the left. For another example, if the first ratio of the first distance to the second distance gradually increases, and the second ratio of the third distance to the fourth distance also gradually increases, it is determined that the moving direction of the specified position is to the right.

The above embodiment is described by using an example in which authentication is performed with reference to the at least two key points of each of the left eye and the right eye. In some embodiments, authentication may alternatively be performed through the at least two key points of the left eye or the right eye. For example, the first distance, the second distance, the third distance, and the fourth distance are still used as an example. If the first ratio of the first distance to the second distance gradually decreases, it may be determined that the moving direction of the specified position is to the left. On the contrary, if the first ratio gradually increases, it may be determined that the moving direction of the specified position is to the right. For another example, If the second ratio of the third distance to the fourth distance gradually decreases, it may be determined that the moving direction of the specified position is to the left. On the contrary, if the second ratio gradually increases, it may be determined that the moving direction of the specified position is to the right.

In this embodiment of this disclosure, the computer device may alternatively continuously obtain images of the left and right eyes of the user, respectively determine the distances between the two corners of each of the left and right eyes and the pupil of each of the left and right eyes, calculate the change trend of the ratio of the distances between the two corners of each of the left and right eyes and the pupil of each of the left and right eyes in this process, so as to determine the moving direction of the position observed by the user, and determine, with reference to the moving direction of the position observed by the user and the moving direction of the specified position indicated by the specified information, whether the authentication on the user succeeds.

The solution of determining, by the computer device in a case that the position that is indicated by the relationship between the first distance, the second distance, the third distance, and the fourth distance and is observed by the user is matched with the specified position, that the authentication on the user succeeds and the solution of determining, by the computer device in a case that the change trend of the first ratio and the change trend of the second ratio are matched with the moving direction of the specified position, that the authentication on the user succeeds may be used separately.

Alternatively, the solution of determining, by the computer device in a case that the position that is indicated by the relationship between the first distance, the second distance, the third distance, and the fourth distance and is observed by the user is matched with the specified position, that the authentication on the user succeeds and the solution of determining, by the computer device in a case that the change trend of the first ratio and the change trend of the second ratio are matched with the moving direction of the specified position, that the authentication on the user succeeds may be combined for use. For example, in a case that the position that is indicated by the relationship between the first distance, the second distance, the third distance, and the fourth distance and is observed by the user is matched with the specified position and the change trend of the first ratio and the change trend of the second ratio are matched with the moving direction of the specified position, the computer device determines that the authentication on the user succeeds.

Based on the solutions involved in the embodiments shown in FIG. 2, for the process in which the computer device performs authentication with reference to the at least two key points of each of the left eye and the right eye, refer to FIG. 4. FIG. 4 is a flowchart of an image processing method for authentication according to an embodiment of this disclosure. In a case that the at least two key points corresponding to the left eye of the user include a plurality of key points on an edge of the pupil of the left eye of the user and the at least two key points corresponding to the right eye of the user include a plurality of key points on an edge of the pupil of the right eye of the user, based on the embodiments shown in FIG. 2, in the embodiments shown in FIG. 4, operation 240 may include operation 240c and operation 240d:

Operation 240c: Obtain a change trend of a first area and a change trend of a second area. The first area is an area of a region surrounded by the plurality of key points at the edge of the pupil of the left eye, and the second area is an area of a region surrounded by the plurality of key points at the edge of the pupil of the left eye.

In the above embodiment, the computer device may control, within a specified time period, a depth of the specified position to gradually increase or decrease. The depth of the specified position may be a distance between the specified position and a human eye. A shorter distance indicates a smaller depth. On the contrary, a longer distance indicates a larger depth.

Meanwhile, a plurality of eye images of each of the left eye and the right eye are acquired within the specified time period. For the plurality of eye images of the left eye, first areas of the plurality of eye images are determined through the plurality of key points at the edges of the pupils in the plurality of eye images, and then the change trend of the first areas is determined according to a sequence of acquisition time points of the plurality of eye images from early to late, namely, whether the first areas gradually increase or gradually decrease is determined. Correspondingly, for the plurality of eye images of the right eye, second areas of the plurality of eye images are determined through the plurality of key points at the edges of the pupils in the plurality of eye images, and then the change trend of the second areas is determined according to a sequence of acquisition time points of the plurality of eye images from early to late, namely, whether the second areas gradually increase or gradually decrease is determined.

Operation 240d: Determine, in a case that the change trend of the first area and the change trend of the second area are matched with a change direction of the depth of the specified position, that the authentication on the user succeeds.

When the user observes objects at different depths (or referred to as distances) with the eyes, pupil areas of the eyes may change. In some aspects, the pupils may contract when the user observes a near object with the eyes and may dilate when the user observes a far object with the eyes. Based on the above principle, in this embodiment of this disclosure, the computer device may control the depth of the specified position to change, determine, through the pupil areas in the acquired eye images of the user, whether a change trend of a depth of a line-of-sight focus of the user is matched the change direction of the depth of the specified position, and determine, if the change trend is matched with the change direction, that the authentication on the user succeeds.

In some aspects, if the first area and the second area gradually decrease, it is determined that the depth of the line-of-sight focus of the user decreases. In this case, if the depth of the specified position gradually decreases, it is determined that the change trend of the depth of the line-of-sight focus of the user is matched with the change direction of the depth of the specified position, and it is determined that the authentication on the user succeeds. Correspondingly, if the first area and the second area gradually increase, it is determined that the depth of the line-of-sight focus of the user increases. In this case, if the depth of the specified position gradually increases, it is determined that the change trend of the depth of the line-of-sight focus of the user is matched with the change direction of the depth of the specified position, and it is determined that the authentication on the user succeeds.

In the solutions shown in the embodiments of this disclosure, the authentication on the user may be implemented by changing the depth of the specified position with reference to the changes in the pupil areas of the user, thereby expanding implementations of the user authentication and improving authentication security.

The above embodiment is described by using an example in which the authentication is performed with reference to the plurality of key points on the edges of the pupils of the left eye and the right eye. In some embodiments, the authentication may alternatively be performed through the plurality of key points at the edge of the pupil of the left eye or the right eye. For example, the first area and the second area are still used as an example. If the first area/the second area gradually decreases, it may be determined that the depth of the line-of-sight focus of the user decreases. On the contrary, if the first area/the second area gradually increases, it may be determined that the depth of the line-of-sight focus of the user increases.

In some embodiments, since the pupil areas of the eyes are related to the distances at which the user observes an object, the areas are further related to a light intensity. Therefore, in this embodiment of this disclosure, in the process of controlling the depth of the specified position to change, the computer device may further control display brightness of the head-mounted display device to be kept unchanged, to avoid interference with the detection of the pupil areas of the user, thereby improving authentication accuracy.

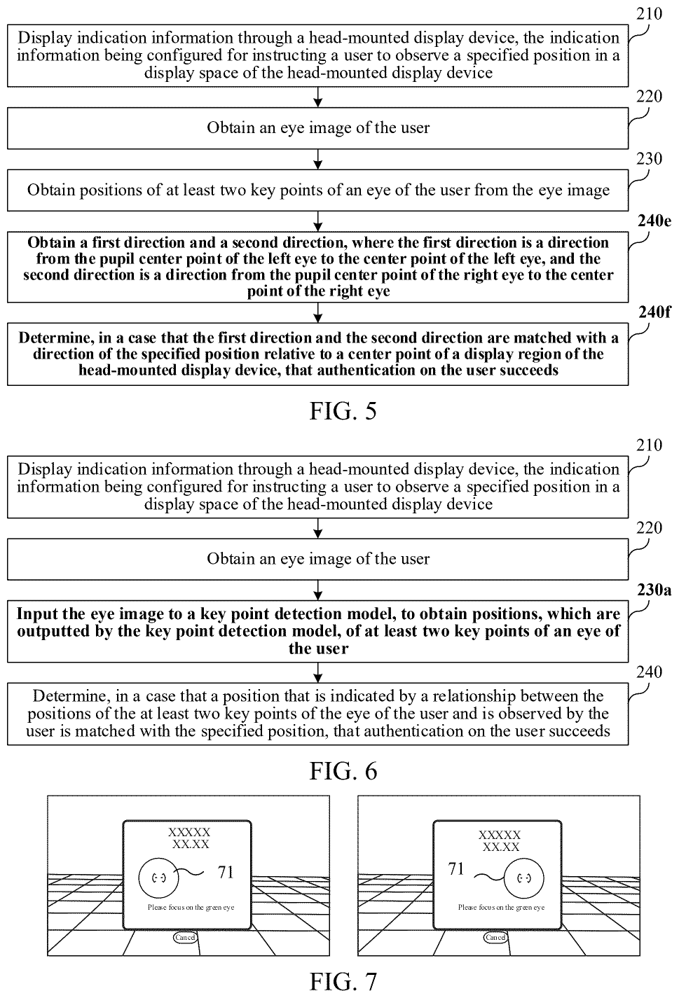

Based on the solutions involved in the embodiments shown in FIG. 2, for the process in which the computer device performs authentication with reference to the at least two key points of each of the left eye and the right eye, refer to FIG. 5. FIG. 5 is a flowchart of an image processing method for authentication according to an embodiment of this disclosure. In a case that the at least two key points corresponding to the left eye of the user include a pupil center point of the left eye of the user and a center point of the left eye of the user, and the at least two key points corresponding to the right eye of the user include a pupil center point of the right eye of the user and a center point of the right eye of the user, based on the embodiments shown in FIG. 2, in the embodiments shown in FIG. 5, operation 240 may include operation 240e and operation 240f:

Operation 240e: Obtain a first direction and a second direction. The first direction is a direction from the pupil center point of the left eye to the center point of the left eye, and the second direction is a direction from the pupil center point of the right eye to the center point of the right eye.

The center point of the left eye may be a center of a region surrounded by the eyelid in the eye image of the left eye. Correspondingly, the center point of the right eye may be a center of a region surrounded by the eyelid in the eye image of the right eye.

Operation 240f: Determine, in a case that the first direction and the second direction are matched with a direction of the specified position relative to a center point of a display region of the head-mounted display device, that the authentication on the user succeeds.

In this embodiment of this disclosure, for one image of each of left and right eyes, the computer device may respectively determine directions of the two pupils of the left and right eyes relative to the centers of the eyes, to determine a direction to which the user looks. With reference to the direction of the specified position relative to the center of the screen, the computer device may determine whether the user observes the specified position, thus determining whether the authentication on the user succeeds. In this solution, a current observation direction of the user can be more accurately detected in conjunction with the observation of the user in the left-right direction and the up-down direction, thus determining whether the user looks to the specified position and improving authentication accuracy and security.

The above embodiment is described by using an example in which the authentication is performed with reference to the directions of the pupil center points of the left eye and the right eye relative to the center points of the eyes. In some embodiments, the authentication may alternatively be performed with reference to the direction of the pupil center point of the left eye or the right eye relative to the center point of the eye. For example, the first direction and the second direction are still used as an example. If the first direction/second direction is matched with the direction of the specified position relative to the center point of the display region of the head-mounted display device, it may be determined that the authentication on the user succeeds.

Based on the solutions shown in one or more of the embodiments involved in FIG. 2 and FIG. 3, FIG. 6 is a flowchart of an image processing method for authentication according to an embodiment of this disclosure. Based on the embodiments shown in FIG. 2, in the embodiments shown in FIG. 6, operation 230 may include operation 230a:

Operation 230a: Input the eye image to a key point detection model, to obtain the positions, which are outputted by the key point detection model, of the at least two key points of the eye of the user.

The key point detection model is a machine learning model that is obtained in advance by training through an eye image sample and the positions of the at least two key points marked by the eye image sample.

In this embodiment of this disclosure, the process of recognizing the at least two key points from the eye image may be implemented by using the machine learning model.

For example, the key point detection model may be a deep learning model that implements classification or regression, for example, an image classification or regression model such as a DeepPose model.

For example, a developer acquires a plurality of eye image samples in advance, and marks positions of at least two key points in each eye image sample; then, inputs the eye image sample to the DeepPose model, to obtain predicted positions, outputted by the DeepPose model, of the at least two key points in the eye image sample; then, calculates, through a preset loss function, a loss according to the positions of the at least two key points marked in the eye image sample and the predicted positions of the at least two key points in the eye image sample; and updates a model parameter of the DeepPose model through the calculated loss, for example, updates the model parameter of the DeepPose model by using a gradient descent algorithm through the calculated loss. The above process is repeated until the DeepPose model is trained to converge. In this case, the DeepPose model may be used as the key point detection model. Subsequently, in an application process, after the computer device inputs the eye image to the key point detection model, the key point detection model may output the positions of the at least two key points in the eye image.

In an embodiment, the solution shown in the above embodiment of this disclosure may be applied to a recognition scenario to implement living body determination. As a core procedure, the solution can effectively ensure recognition security, and a recognition attack caused by a paper attack or a false eye attack can be avoided.

For example, this solution provides a living body determining algorithm for recognizing a behavior intention based on attention determination. Different object scenarios are constructed in a VR scenario, to guide the eyes to look to different directions. Whether the attention of the user conforms to an object guidance direction is predicted by determining positions and shapes of the eyes and positions and shapes of the irises, so as to determine whether the operation of the user is an in-person operation.

From a product side, after a user wears a VR device, a recognition camera may continuously acquire photos of the eyes of the user. Different object scenarios are constructed in a VR scenario to guide the eyes to look to different directions. Whether the attention of the user conforms to an object guidance direction is predicted by determining positions of key points in the eyes and shapes or sizes of regions surrounded by the key points, so as to determine whether the operation of the user is an in-person operation.

From a technical side, the solution includes the following three parts:

### I) Construction of a VR Scenario: Including Moving an Object to Left and Right Positions, and the Like

In this solution, Unity may be used to construct a VR 3D scenario. For example, FIG. 7 is a schematic diagram of a scenario interface according to this disclosure. As shown in FIG. 7, in this scenario, a panel is always right in front of two eyes of a user, and a position of an eye icon 71 changes. Changing the position of the eye icon 71 guides the user to focus on, so that the eyeballs of the user are guided to roll to the left or the right to look to the left or the right.

### II) Determination of a Positions and Shape of an Eye and a Position and Shape of the Iris: Calculation of Key Points of Pupil, Iris, and Eyelid Regions Based on DeepPose

Estimation of an eyeball attention point depends on the position of the eye, the position of the pupil, and a relative position between the pupil and the eye, so that an eye attention point can be correctly estimated, thus evaluating whether the attention of the user satisfies interactive guidance and then determining whether the user is a living body. Regarding size and position information of the iris, key point estimation may be performed through DeepPose, and an accurate size and position of the iris may be calculated based on calculated positions of key points. The following first describes the principle of the DeepPose algorithm:

A core idea of the DeepPose algorithm is described as follows:

In a conventional posture recognition field, a knowledge system of interactions between limbs is usually used to design relatively complex models such as feature representations of some images or a topology between joints.

The idea of the DeepPose is not to consider somatological problems in complex postures, instead, to change a key point detection algorithm into a pure mathematics prediction problem. By artificially annotating a large amount of human body key point data in various postures, sample data is learned through a deep neural network (DNN) convolutional neural network, so that a more general end-to-end key point detection algorithm is implemented.

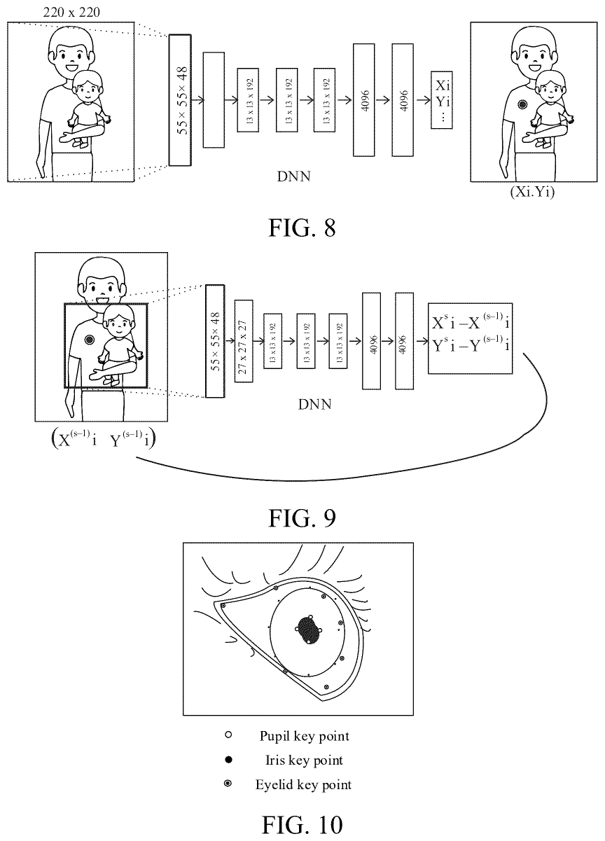

FIG. 8 is a diagram of a principle of a DeepPose algorithm. As shown in FIG. 8, after a series of convolution is performed on an image of 220*220, (xi, yi) of a final target position is finally obtained through two fully connected layers. This algorithm is not limited to being applied only to a human body, and is still applicable to an iris region. This algorithm is a general-purpose key point prediction algorithm itself.

The DeepPose algorithm may be further optimized. For example, FIG. 9 is a diagram of a principle of another DeepPose algorithm. As shown in FIG. 9, due to an uncertain size of an input target, a network itself only receives an input of 220*220. As a result, there may be an error in final target position prediction. In view of this, in the second stage of the above algorithm, the idea of the first stage is continued to be used. Regions around the estimated point positions are cut and enlarged for continuous more accurate prediction, thereby improving final prediction accuracy.

The core idea of the DeepPose algorithm is also fitting of a DNN network to a nonlinear regression problem, to implement end-to-end returning of a network prediction result. For example, FIG. 10 is a schematic diagram of prediction of key points of an eye through a DeepPose algorithm according to this disclosure. FIG. 10 shows 19 key points of an eye region that are returned after DeepPose prediction.

Hollow dotted key points are estimation of key points of the eyelid. Solid key points are estimation of points around the iris. Hollow key points are estimation of points around the pupil. Since the pupil itself is a circular region, and in an iris recognition scenario, the pupil may be guided to contract through environment adjustment, and an imaging distortion is not large at a small angle. Therefore, four key points are configured as pupil key points. The iris region is larger than the pupil, and the upper right side of the iris region is easily blocked by the eyelid. Therefore, the iris region uses eight key points for registration. Similarly, an upper part of the eyelid region has a larger curve radian than a lower part of the eyelid region. Therefore, the upper part uses more key points, namely, six key points, for registration.

### III) Calculation of a Size of the Pupil and a Size of the Iris Region Based on the Pupil, Iris, and Eyelid Key Points, to Determine an Attention Point of the User, Thus Determining Whether the User is a Living Body

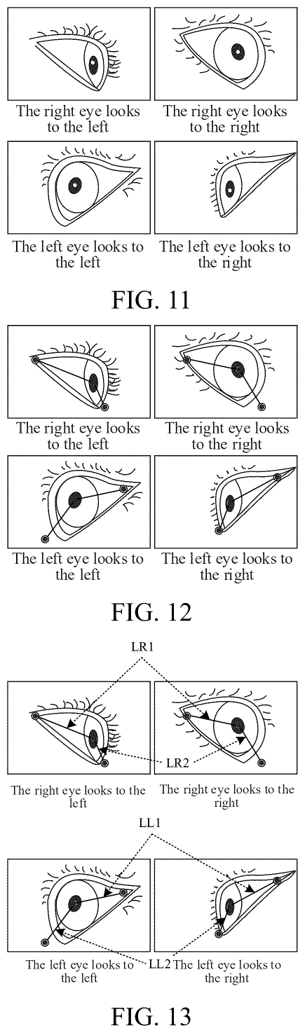

As can be seen from FIG. 10, the positions of the key points of the human eye may be obtained by using the DeepPose algorithm. FIG. 11 is a diagram of presentations of two eyes when the two eyes look to the left and to the right according to this disclosure.

By key point detection, FIG. 12 is an effect diagram of key point detection according to this disclosure. As shown in FIG. 12, displaying of key points that are not of concern is eliminated, and key points of two corners of the eyelid and key points at a boundary of the pupil are maintained. Based on the iris key points shown in FIG. 10, the pupil region and the iris region are circular regions, which may be changed into elliptical regions due to an angle distortion or the like. However, considering that a small pupil region may be less affected by the distortion, and excessive registration points may cause a large error. In this embodiment of this disclosure, a circular pupil region, namely the above pupil center point, is determined by using four key points at the boundary of the pupil.

Points in a center region of the pupil may be roughly calculated through the four points in the pupil region. A calculation formula is:

$${x}^{′} = ( min ( x ) + max ( x ) ) / 2$$

$${y}^{′} = ( min ( y ) + max ( y ) ) / 2$$

where min (x), min (y), max (x), and max (y) represent minimum values and maximum values of x and y of coordinate positions of all the four points.

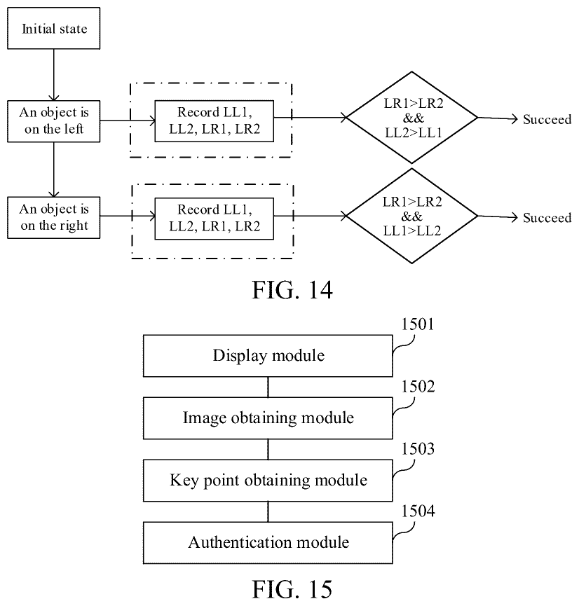

FIG. 13 is a schematic diagram of connecting lines between corners and pupils according to this disclosure. As shown in FIG. 13, it can be seen that when a user looks to the left and looks to the right, proportions of lengths of connecting lines between the two corners and the pupil of each of left and right eyes are significantly distinguished. In some aspects: FIG. 14 is a flowchart of authentication according to this disclosure. As shown in FIG. 14, the authentication logic may be as follows:
if (LR1>LR2 & & LL2>LL1): looking to the left; and
if (LR1>LR2 & & LL1>LL2): looking to the right.

This is because when human eyes are guided to look to the left and to the right in a VR scenario, due to the design of a guidance animation, a user cannot see an object by turning the head of the user, but can see an object only by rolling the eyeballs. During the rolling of the eyeballs to the left or the right, the relative position between the pupil and an eyelid corner may change. Based on the change, an eyeball action may be determined, thereby determining whether the user performs living body authentication according to a direction requirement in the VR animation.

The above position is determined by simply using the magnitudes, or by introducing proportions or various determining factors. Meanwhile, in the above solution, determining whether the direction is to the left or to the right is only described. Similarly, various other angle positions (for example, up and down) may be further estimated and determined, provided that different distance determining conditions are used in different scenarios.

This solution mainly relies on the DeepPose algorithm to estimate the iris key points, and determines the positional relationship between the pupil and the corners under the guidance of the animation in the VR, thus determining whether to look to the left or the right and further determining whether a living body meets a requirement. In this solution, a living body may be determined in a VR scenario in a case of a natural experience of a user.

In some embodiments, a head-mounted display device is provided, including a display screen and an image acquisition component, the image acquisition component pointing to an eyeball position when the head-mounted display device is worn; the display screen being configured to display indication information, the indication information being configured for instructing a user to observe a specified position in a display space of the head-mounted display device; the image acquisition component being configured to acquire an eye image of the user; and the eye image being configured for obtaining positions of at least two key points of an eye of the user, so as to determine, in a case that a position that is indicated by a relationship between the positions of the at least two key points of the eye of the user and is observed by the user is matched with the specified position, that authentication on the user succeeds. The operation of determining, in a case that a position that is indicated by a relationship between the positions of the at least two key points of the eye of the user and is observed by the user is matched with the specified position, that authentication on the user succeeds may be performed by the head-mounted display device, for example, by a controller/controller arranged in the head-mounted display device. Alternatively, the operation of determining, in a case that a position that is indicated by a relationship between the positions of the at least two key points of the eye of the user and is observed by the user is matched with the specified position, that authentication on the user succeeds may be performed by a terminal connected to the head-mounted display device. For the solution in which the head-mounted display device or the terminal performs the authentication on the user, refer to the above embodiments.

The following describes apparatus embodiments of this disclosure, which may be configured for performing the method embodiments of this disclosure. For details not disclosed in the apparatus embodiments of this disclosure, refer to the method embodiments of this disclosure.

FIG. 15 is a block diagram of an image processing apparatus for authentication according to an embodiment of this disclosure. The apparatus may include the following modules:
a display module 1501, configured to display indication information through a head-mounted display device, the indication information being configured for instructing a user to observe a specified position in a display space of the head-mounted display device;
an image obtaining module 1502, configured to obtain an eye image of the user;
a key point obtaining module 1503, configured to obtain positions of at least two key points of an eye of the user from the eye image; and
an authentication module 1504, configured to determine, in a case that a position that is indicated by a relationship between the positions of the at least two key points of the eye of the user and is observed by the user is matched with the specified position, that authentication on the user succeeds.

In some embodiments, the head-mounted display device is a virtual reality (VR) display device, or the head-mounted display device is an augmented reality (AR) display device.

In some embodiments, the display module 1501 is configured to display the indication information at the specified position through the VR display device or the AR display device.

In some embodiments, the image obtaining module 1502 is configured to obtain the eye image acquired by an image acquisition component arranged in the head-mounted display device; and the image acquisition component points to an eyeball position when the head-mounted display device is worn.

In some embodiments, the at least two key points of the eye of the user include at least one of the following:
at least two key points corresponding to the left eye of the user; and
at least two key points corresponding to the right eye of the user.

In some embodiments, the at least two key points corresponding to the left eye of the user include a left corner key point of the left eye of the user, a right corner key point of the left eye of the user, and a pupil center point of the left eye of the user; and
the at least two key points corresponding to the right eye of the user include a left corner key point of the right eye of the user, a right corner key point of the right eye of the user, and a pupil center point of the right eye of the user; and

The authentication module 1504 is configured to:
obtain a first distance, a second distance, a third distance, and a fourth distance, the first distance being a distance between the left corner key point of the left eye and the pupil center point of the left eye; the second distance being a distance between the right corner key point of the left eye and the pupil center point of the left eye; the third distance being a distance between the left corner key point of the right eye and the pupil center point of the right eye; the fourth distance being a distance between the right corner key point of the right eye and the pupil center point of the right eye; and
determine, in a case that a position that is indicated by a relationship between the first distance, the second distance, the third distance, and the fourth distance and is observed by the user is matched with the specified position, that the authentication on the user succeeds.

In some embodiments, the authentication module 1504 is configured to:
determine a viewing direction of the user based on a magnitude relationship between the first distance, the second distance, the third distance, and the fourth distance; and
determine, in a case that the viewing direction of the user is matched with the specified position, that the authentication on the user succeeds.

In some embodiments, the authentication module 1504 is configured to:
determine, in a case that the second distance is greater than the first distance and the fourth distance is greater than the third distance, that the viewing direction of the user is toward the left; and
determine, in a case that the first distance is greater than the second distance and the third distance is greater than the fourth distance, that the viewing direction of the user is toward the right.

In some embodiments, the specified position moves with time; and the authentication module 1504 is configured to:
obtain a change trend of a first ratio of the first distance to the second distance;
obtain a change trend of a second ratio of the third distance to the fourth distance; and
determine, in a case that the change trend of the first ratio and the change trend of the second ratio are matched with a moving direction of the specified position, that the authentication on the user succeeds.

In some embodiments, the key point obtaining module 1503 is configured to input the eye image to a key point detection model, to obtain the positions, which are outputted by the key point detection model, of the at least two key points of the eye of the user,
the key point detection model being a machine learning model that is obtained in advance by training through an eye image sample and the positions of the at least two key points marked by the eye image sample.

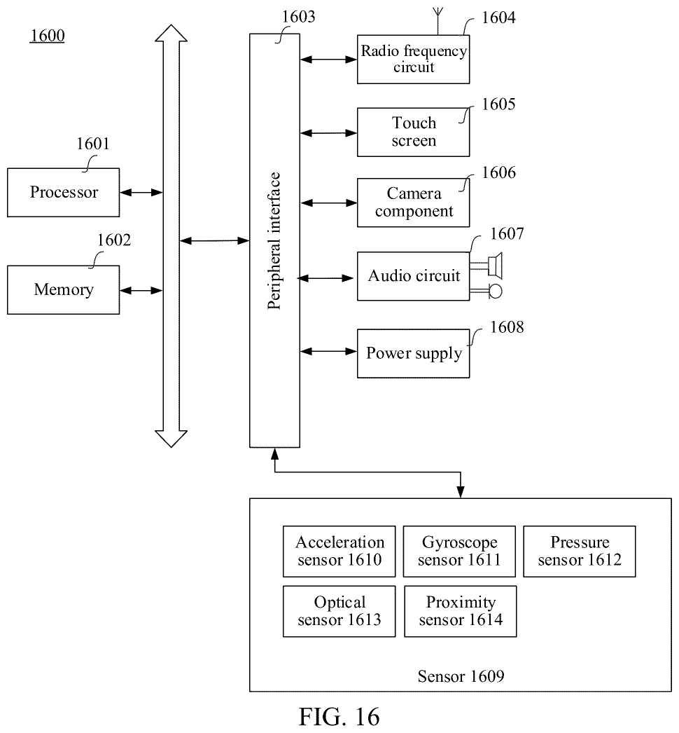

FIG. 16 is a structural block diagram of a computer device 1600 according to an embodiment of this disclosure. The computer device 1600 may be a terminal device, for example: a personal computer, a VR device, an AR device, a smartphone, a tablet computer, a moving picture experts group audio layer III (MP3) player, or a moving picture experts group audio layer IV (MP4) player. The computer device 1600 may alternatively be referred to as a user device, a portable terminal, or other names.

Generally, the computer device 1600 includes: a processor 1601 and a memory 1602.

The memory 1602 may include one or more computer-readable storage mediums. The computer-readable storage mediums may be tangible and non-transitory. The memory 1602 may further include a high-speed random access memory and a nonvolatile memory, for example, one or more disk storage devices or flash storage devices. In some embodiments, each non-transitory computer-readable storage medium in the memory 1602 is configured to store at least one instruction, and the at least one instruction is configured for being executed by the processor 1601, to implement all or part of the operations performed by a terminal in the method provided in the embodiments of this disclosure.

In some embodiments, the computer device 1600 may alternatively include: a peripheral interface 1603 and at least one peripheral. In some aspects, the peripheral includes: at least one of a radio frequency (RF) circuit 1604, a touch display screen 1605, a camera component 1606, an audio circuit 1607, and a power supply 1608.

In some embodiments, the computer device 1600 further includes one or more sensors 1609. The one or more sensors 1609 include, but are not limited to: an acceleration sensor 1610, a gyroscope sensor 1611, a pressure sensor 1612, an optical sensor 1613, and a proximity sensor 1614.

A person skilled in the art may understand that the structures shown do not constitute a limitation on the computer device 1600, and the computer device 900 may include more components or fewer components than those shown in the figure, or some components may be combined, or a different component deployment may be used.

In an embodiment, a computer-readable storage medium is further provided, which is configured for having at least one computer program stored therein, the at least one computer program is loaded and executed by a processor to implement all or part of the operations in the method shown in the above embodiments. For example, the computer-readable storage medium may be a read only memory, a random access memory, a compact disc read only memory, a magnetic disc, a floppy disk, an optical data storage device, or the like,

In an embodiment, a computer program product is further provided. The computer program product includes a computer program, and the computer program is stored in a computer-readable storage medium. A processor of a computer device reads the computer program from the computer-readable storage medium and executes the computer program, to cause the computer device to perform all or part of the operations in the method shown in the above embodiments.

According to this disclosure, a prompt interface or a pop-up window may be displayed, or voice prompt information may be outputted before and during collecting user-related data of a user. The prompt interface, the pop-up window, or the voice prompt information is configured for prompting the user that data related to the user is currently being collected, so that this disclosure only starts to perform related operations of obtaining the user-related data after obtaining a confirmation operation of the user for the prompt interface or the pop-up window, otherwise (namely, when the confirmation operation of the user for the prompt interface or the pop-up window is not obtained), ends the related operations of obtaining the user-related data, namely, skips obtaining the user-related data.

In other words, all user data acquired in this disclosure is acquired with the consent and authorization of a user, and acquisition, use, and processing of the relevant user data need to comply with the relevant laws, regulations, and standards of relevant countries and regions.

The relevant user data includes data such as information (including but not limited to an account of the user), data (including but not limited to text data entered by the user, stored text/image data, presented text/image data, and the like), and a signal. For example, the user data involved in this disclosure is obtained under full authorization.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The foregoing disclosure includes some embodiments of this disclosure which are not intended to limit the scope of this disclosure. Other embodiments shall also fall within the scope of this disclosure.

What is claimed is:

1. A method of image processing for authentication, comprising:
displaying indication information by a head-mounted display device, the indication information instructing a user of the head-mounted display device to observe a specified position in a display space of the head-mounted display device;
obtaining an eye image of the user;
obtaining key point positions of at least two key points of an eye of the user from the eye image;
determining an observing position of the user based on relationships between the key point positions of the at least two key points; and
determining, when the observing position of the user matches with the specified position, that an authentication of the user succeeds.

2. The method according to claim 1, wherein the head-mounted display device is a virtual reality (VR) display device, or the head-mounted display device is an augmented reality (AR) display device.

3. The method according to claim 2, wherein the displaying the indication information comprises:
displaying the indication information at the specified position through the VR display device or the AR display device.

4. The method according to claim 1, wherein the obtaining the eye image of the user comprises:
acquiring the eye image by an image acquisition component of the head-mounted display device; and the image acquisition component being arranged to point to an eyeball position of the user when the head-mounted display device is worn on the user.

5. The method according to claim 1, wherein the at least two key points comprise at least one of:
first two or more key points of a left eye of the user; and
second two or more key points of a right eye of the user.

6. The method according to claim 5, wherein:
the first two or more key points comprise a left corner key point of the left eye of the user, a right corner key point of the left eye of the user, and a pupil center point of the left eye of the user;
the second two or more key points comprise a left corner key point of the right eye of the user, a right corner key point of the right eye of the user, and a pupil center point of the right eye of the user; and
the determining the observing position comprises:
calculating a first distance, a second distance, a third distance, and a fourth distance, the first distance being a distance between the left corner key point of the left eye and the pupil center point of the left eye; the second distance being a distance between the right corner key point of the left eye and the pupil center point of the left eye; the third distance being a distance between the left corner key point of the right eye and the pupil center point of the right eye; the fourth distance being a distance between the right corner key point of the right eye and the pupil center point of the right eye; and
determining, the observing position of the user based on comparisons of the first distance, the second distance, the third distance, and the fourth distance.

7. The method according to claim 6, wherein the determining the observing position comprises:
determining a viewing direction of the user based on magnitude comparisons of the first distance, the second distance, the third distance, and the fourth distance.

8. The method according to claim 7, wherein the determining the viewing direction comprises:
determining, when the second distance is greater than the first distance and the fourth distance is greater than the third distance, that the viewing direction of the user is toward a left direction; and
determining, when the first distance is greater than the second distance and the third distance is greater than the fourth distance, that the viewing direction of the user is toward a right direction.

9. The method according to claim 6, wherein:
the specified position moves with time; and
the determining that the authentication on the user succeeds comprises:
obtaining a first change trend of a first ratio of the first distance to the second distance;
obtaining a second change trend of a second ratio of the third distance to the fourth distance; and
determining, when the first change trend of the first ratio and the second change trend of the second ratio match with a moving direction of the specified position, that the authentication on the user succeeds.

10. The method according to claim 1, wherein the obtaining the key point positions comprises:
inputting the eye image to a key point detection model, to obtain the key point positions that are outputted by the key point detection model, and
the key point detection model being a machine learning model that is obtained in advance by training through eye image samples and respectively marked key point positions of the eye image samples.

11. An image processing apparatus for authentication, comprising processing circuitry configured to:
provide indication information to display by a head-mounted display device, the indication information instructing a user of the head-mounted display device to observe a specified position in a display space of the head-mounted display device;
obtain an eye image of the user;
obtain key point positions of at least two key points of an eye of the user from the eye image;
determine an observing position of the user based on relationships between the key point positions of the at least two key points; and
determine, when the observing position of the user matches with the specified position, that an authentication of the user succeeds.

12. The image processing apparatus according to claim 11, wherein the head-mounted display device is a virtual reality (VR) display device, or the head-mounted display device is an augmented reality (AR) display device.

13. The image processing apparatus according to claim 12, wherein the VR display device or the AR display device displays the indication information at the specified position.

14. The image processing apparatus according to claim 11, wherein the processing circuitry is configured to:
acquire the eye image via an image acquisition component of the head-mounted display device; and the image acquisition component being arranged to point to an eyeball position of the user when the head-mounted display device is worn on the user.

15. The image processing apparatus according to claim 11, wherein the at least two key points comprise at least one of:
first two or more key points of a left eye of the user; and
second two or more key points of a right eye of the user.

16. The image processing apparatus according to claim 15, wherein:
the first two or more key points comprise a left corner key point of the left eye of the user, a right corner key point of the left eye of the user, and a pupil center point of the left eye of the user;
the second two or more key points comprise a left corner key point of the right eye of the user, a right corner key point of the right eye of the user, and a pupil center point of the right eye of the user; and
the processing circuitry is configured to:
calculate a first distance, a second distance, a third distance, and a fourth distance, the first distance being a distance between the left corner key point of the left eye and the pupil center point of the left eye; the second distance being a distance between the right corner key point of the left eye and the pupil center point of the left eye; the third distance being a distance between the left corner key point of the right eye and the pupil center point of the right eye; the fourth distance being a distance between the right corner key point of the right eye and the pupil center point of the right eye; and
determine, the observing position of the user based on comparisons of the first distance, the second distance, the third distance, and the fourth distance.

17. The image processing apparatus according to claim 16, wherein the processing circuitry is configured to:
determine a viewing direction of the user based on magnitude comparisons of the first distance, the second distance, the third distance, and the fourth distance.

18. The image processing apparatus according to claim 17, wherein the processing circuitry is configured to:
determine, when the second distance is greater than the first distance and the fourth distance is greater than the third distance, that the viewing direction of the user is toward a left direction; and
determine, when the first distance is greater than the second distance and the third distance is greater than the fourth distance, that the viewing direction of the user is toward a right direction.

19. The image processing apparatus according to claim 16, wherein:
the specified position moves with time; and
the processing circuitry is configured to:
obtain a first change trend of a first ratio of the first distance to the second distance;
obtain a second change trend of a second ratio of the third distance to the fourth distance; and
determine, when the first change trend of the first ratio and the second change trend of the second ratio match with a moving direction of the specified position, that the authentication on the user succeeds.

20. A non-transitory computer-readable storage medium storing instructions which when executed by at least one processor cause the at least one processor to perform:
providing indication information to display by a head-mounted display device, the indication information instructing a user of the head-mounted display device to observe a specified position in a display space of the head-mounted display device;
obtaining an eye image of the user;
obtaining key point positions of at least two key points of an eye of the user from the eye image;
determining an observing position of the user based on relationships between the key point positions of the at least two key points; and
determining, when the observing position of the user matches with the specified position, that an authentication of the user succeeds.
